(19) United States
(12) Patent Application Publication
(10) Pub. No.: US 2020/0210377 A1
(43) Pub. Date: Jul. 2, 2020

(54) CONTENT MANAGEMENT SYSTEM AND METHOD

(71) Applicant: Target Brands, Inc., Minneapolis, MN (US)

(72) Inventors: LUCAS STRUCK, Minneapolis, MN (US); BRENT MESSING, Gem Lake, MN (US); RYAN VILMO, Buffalo, MN (US)

(21) Appl. No.: 16/235,764

(22) Filed: Dec. 28, 2018

(51) Int. Cl. G06F 16/11; G06K 9/00; G06F 21/62; G06F 9/54

(52) U.S. Cl. CPC G06F 16/125; G06K 9/00469; G06K 2209/01; G06F 9/54; G06F 21/6218

(57) ABSTRACT

A computer-implemented system and method for managing the ingestion, storage, and destruction of documents in an enterprise system. The system includes a plurality of cooperative microservices for receiving an unstructured document, processing the document, applying a retention policy, executing a destruction policy, and applying a security policy, where each microservice is capable of functioning independently of each other.

### TECHNICAL FIELD

The present disclosure relates to a scalable document storage and organization system.

### BACKGROUND

Organizations generate a large amount of digital and physical information every day. Some of that information needs to be stored electronically and retained for a specific and prolonged period of time. The information may originate in different formats, such as pictures, hard-copy documents, e-mails, and other electronic documents. Increasingly, hard copy documents are being converted to digital copies, and need to be stored in their electronic form. Currently, hard copy documents are scanned by an individual and documents are stored electronically for a defined period of time. Not all of this data is typically captured in a way that is readily indexable; to the contrary, scanned documents are often captured in image form only, and as such, the only available metadata regarding those documents may be, e.g., a time of capture, user, and file size. Other contextual information regarding the contents or structure of the document may also be lacking. Accordingly, this data, referred to as “unstructured” data, is challenging to logically capture and determine when it may be appropriate to store or discard in existing document management systems.

The volume of information generated and stored by a company continues to grow over time and the information companies must retain directly correlates to this growth. Companies are faced with increasing costs associated with the effort to properly categorize information to remain compliant with legal and regulatory retention requirements.

Consequently, organizations generally apply overly broad or inclusive retention policies that keep all electronic documents uploaded to their systems. Such retention policies requires large amounts of storage, and can make the process of finding specific documents difficult and time-consuming. Content miscategorized with shorter retention policies can cause compliance and regulatory risk when a needed document has been deleted.

Existing tools used for managing document retention are generally closed-source systems, and provide limited ability to perform maintenance or have insight into the inner workings of the system. Corporations are reliant on features and functionality that are not customized to their needs.

Still further, in many cases, multiple systems are required to be interconnected, with each system having its own way of defining storage or retention policies, security standards, and rigor for feature testing, upgrades, and reliability. When one portion of such a multi-solution system is upgraded, it often results in required updates or fixes to other portions of an enterprise document retention system. Accordingly, existing monolithic software solutions, even when multiple are used, present problems in terms of reliable, flexible management of enterprise data.

### SUMMARY

In general, the subject matter of this disclosure is a content storage and organization system that can be used to enforce an organization's document retention policy while also allowing the organization to search for and locate documents that may be difficult to otherwise find, e.g., due to a lack of searchable contextual information associated with the document. In particular, the document storage and organization system allows for storage of “unstructured” data, such as TIFF, PDF, or PNG data. This can also be used for storage of images of paper documents, to the extent such documents require preservation.

In particular, in a first aspect, a system for managing unstructured documents within an enterprise system is provided. The system includes a computing system comprising at least one processor communicatively connected to memory configured to store instructions which, when executed, cause the computing system to: expose an application programming interface (API) representing a single access point to a document management repository including a plurality of microservices including: an ingestion service configured to receive at least one document, wherein the document lacks a predictable internal structure, and processes at least one document for storage; a metadata service configured to apply metadata to at least one document where the metadata is selected for tagging at least one document with a time, date, creator, security policy, and destruction policy; a retention policy service configured to apply a minimum retention period and destruction policy; and a storing service configured to store at least one document and associated metadata for at least the minimum retention period; and wherein each service is capable of functioning independently of each other service.

In another aspect, a method of processing at least one unstructured document from an enterprise system is provided. The method comprises ingesting at least one unstructured document at an ingestion service and processing at least one unstructured document for storage; applying metadata to at least one unstructured document by a metadata service, the application of tagging metadata to at least one unstructured document with at least one metadata type including time, date, creator, security policy, and destruction policy; applying a minimum retention period to at least one unstructured document by a retention policy service; application of a destruction policy to at least one unstructured document by the retention policy service; and storing at least one unstructured document and associated metadata for at least the minimum retention period within a storing service.

In yet another aspect, a system architecture for managing documents lacking a predictable internal structure with an enterprise system comprises: a computing system comprising at least one processor communicatively connected to memory, the memory storing computer-executable instructions comprising an application programming interface (API); a means for receiving at least one unstructured document and processing the unstructured document for storage; a means for applying metadata to at least one unstructured document; a means for applying a retention policy comprising a minimum retention period and destruction policy to at least one unstructured document; and a means for storing at least one unstructured document and associated metadata for the minimum retention period; wherein the means for receiving, the means for applying metadata, the means for applying a retention policy, and the means for storing are capable of communicating with each other and capable of functioning independently of each other.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of a system for managing documents within an enterprise system.

FIG. 2 illustrates an example block diagram of a computing system usable in the document management system.

FIG. 3 illustrates an example block diagram of an architecture for a document management system.

FIG. 4 is an example method of using a document manage system.

FIG. 5 illustrates an example block diagram of an architecture for a document management system.

FIG. 6 shows an example method of using to document management system to manage unstructured documents.

FIG. 7 shows an example method of a define step of the data flow of the document management system.

FIG. 8 illustrates an example architecture of the define step of the data flow.

FIG. 9 shows an example method of a declare step of the data flow of the document management system.

FIG. 10 illustrates an example architecture of the declare step of the data flow.

FIG. 11 shows an example method of a discover step of the data flow of the document management system.

FIG. 12 illustrates an example architecture of the discover step of the data flow.

FIG. 13 shows an example method of a download step of the data flow of the document management system.

FIG. 14 illustrates an example architecture of the download step of the data flow.

FIG. 15 is shows an example method of a destroy step of the data flow of the document management system.

FIG. 16 illustrates an example architecture of the destroy step of the data flow.

FIG. 17 displays a schematic diagram of an example computing system usable in the system of FIG. 1.

### DETAILED DESCRIPTION

Various embodiments will be described in detail with reference to the drawings, wherein like reference numerals represent like parts and assemblies throughout several views. Reference to various embodiments does not limit the scope of the claims attached hereto. Additionally, any examples set forth in this specification are not intended to be limiting and merely set forth some of the many possible embodiments for the appended claims.

As briefly described above, embodiments of the present invention are directed to systems and methods of managing electronic content. The systems described herein provide an architecture that meets compliance needs through a content management solution, and provide for flexible management of unstructured data in alignment with the storage and preservation requirements of an organization.

An enterprise-wide records management system as described herein includes ingesting, sorting, categorizing, storing, searching, and destroying electronic content items. Content items are described herein as documents, but this is not to be seen as limiting. The system is capable of ingesting any type of document, herein referred to as an unstructured document. An unstructured document includes, but is not limited to, text documents, pictures, e-mail, PDF's, scanned hard-copy documents, and any other electronic document that lacks a predictable internal structure.

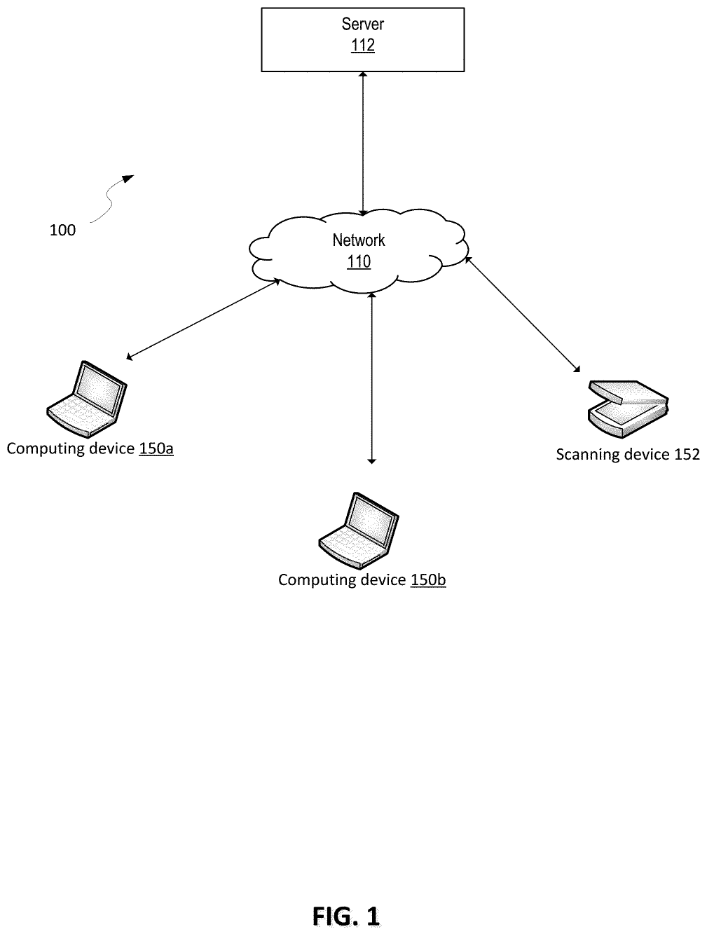

Referring to FIGS. 1-19 generally, a system and method for managing content across an enterprise system is described. The system includes a micro-service architecture, where each micro-service preforms a different function, but can communicate with each other. The micro-services are scalable independently of each other, to accommodate the needs of the system. The specifics and alternative embodiments are described in detail below.

FIG. 1 illustrates a system 100 for managing documents to be stored for an enterprise system. The system includes a network 110 (e.g., the Internet) communicatively connected to a server 112 and at least one connected device.

Connected devices include, for example, computing devices 150a, 150b, and scanning device 152. Computing devices are any device capable of receiving a document to be managed by the system. For example, a computing device 150 may receive an email, or the computing device 150 may store a digital document. In another example, a hard-copy document is scanned by scanning device 152.

While only two computing devices 150 and a scanning device 152 are shown, other devices are contemplated. Other non-limiting examples of connected devices include tablets, phones, printers, fax devices, or any other device or mechanism capable communicating by means of a digital communication protocol. Still further, more than one device is connected to network 110, and as many devices as necessary may be connected.

The network 110 allows for communication between the one or more computing devices in the system 100. The network 110 can be a wired network or a wireless network such as the Internet, or an enterprise network (e.g., LAN, WAN, etc.).

The server 112 stores data received from the computing devices 150 and/or scanning device 152 via the network 110. Although, in the example shown, a single server 112 is depicted, it is recognized that any number of server devices may be used. However, in accordance with the present disclosure, the server 112 provides a single application programming interface (API) at which documents may be submitted for processing and storage. In example implementations, the server 112 is implemented using a microservices architecture in which individual tasks are performed by discrete modules, which are interconnected via a set of communication protocols. Accordingly, the server 112 is readily scalable in accordance with the document processing and storage requirements of an enterprise.

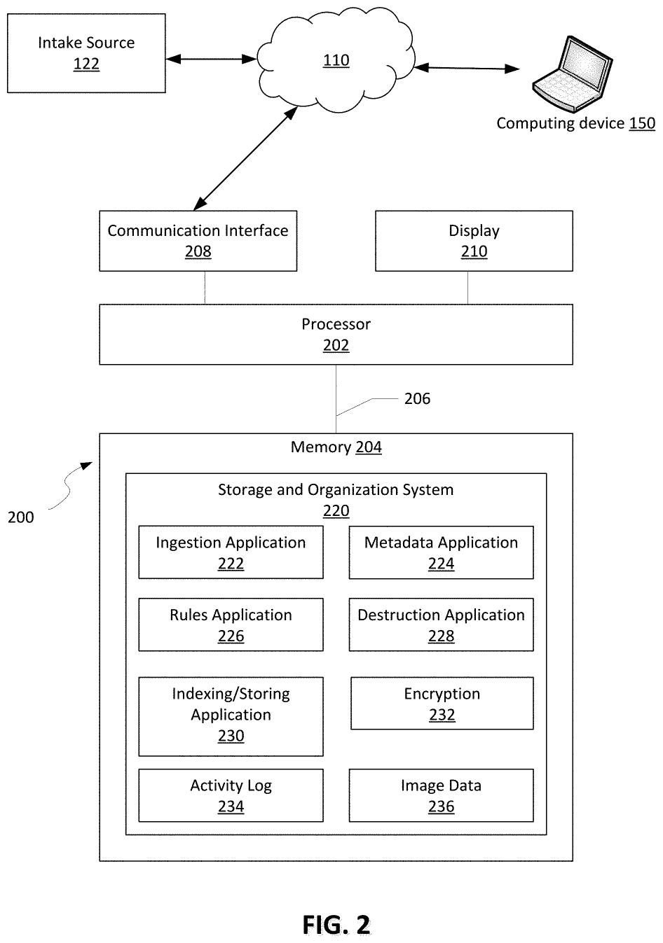

FIG. 2 illustrates a schematic diagram of an overall system 200 for managing documents in an enterprise system. The system 200 includes an intake source 122, which can receive documents, such as faxes, digital documents, scans, and e-mails. The system 200 also includes a computing device 150, which can also receive and provide documents to be ingested. The system 200 includes a storage and organization system 220, communicatively connected to the computing device 150 via network 110 (e.g., the Internet). As noted above with respect to FIG. 1, although the system 200 is depicted schematically as a single computing system it is recognized that in the present disclosure the system 200 can be implemented across a plurality of computing systems, and in fact typically would be implemented in that way based on the microservices architecture that is utilized. Still further, over time the number of computing systems used may vary since each microservice may scale up and down based on the demands on the overall system 200 (e.g., based on a rate of receipt of documents and/or document requests).

In the embodiment shown components of the overall system 200 include a communication interface 208 and a display 210 connected to a processor 202. The processor 202 is connected to the memory 204 through a bus 206. The processor 202 can be any of a variety of types of programmable circuits capable of executing computer-readable instructions to perform various tasks, such as mathematical and communication tasks. The memory 204 includes the storage and organization system 220.

The memory 204 can include any of a variety of memory devices, such as using various types of computer-readable or computer storage media. A computer storage medium or computer-readable medium may be any medium that can contain or store the program for use by or in connection with the instruction execution system, apparatus, or device. By way of example, computer storage media may include dynamic random-access memory (DRAM) or variants thereof, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally includes at least one or more tangible media or devices. Computer storage media can, in some embodiments, include embodiments including entirely non-transitory components. In the embodiment shown, the memory 204 stores a storage and organization system 220, discussed in further detail below.

The overall system 200 can also include a communication interface 208 configured to receive and transmit data, for example to access data in an external database. Optionally, a display 210 can be used for viewing documents generated by system 220 (although typically, such data is stored for retrieval from memory rather than being locally displayed).

In the embodiment shown, storage and organization system 220 includes an ingestion application 222, metadata application 224, rules application 226, destruction application 228, indexing/storage application 230, encryption application 232, activity log 234, and image data application 236.

Ingestion application 222 manages the ingestion of documents for storage in the system. The ingestion application 222 receives information to be processed and stored by storage and organization system 220 from an intake source 122 or computing device 150. Example sources include faxes, scanned documents, digital documents, and email communications.

The ingestion application 222 may also process the document by applying an optical character-recognition (OCR) or intelligent character-recognition (ICR) software to the document, classifying the document, and/or converting the document from a fixed format to a flow format or vice versa.

Documents, as used herein, refers to any type of data that needs to be stored within the system. Content includes any type of written document, digital document, audio content, video content, communications, and other similar types of content comprising information that may need to be archived. Documents may be unstructured data, such as PDF, TIFF, or other types of files. Still further, documents may be hard-copy documents that have been converted or are being converted to digital copies. The ingestion application 222 processes the content contained within the documents before it gets to the back-end storage. As part of the ingestion process, metadata may be added as necessary to the document.

Metadata application 224 can apply metadata tags that are relevant to the document. Example tags include the document's technical aspects, such as the format, size, creation data, author, workflow, and subject matter of the file.

Rules application 226 maintains and logs the rules associated with each document. Rules include, but are not limited to, retention policy, encryption policy, viewing and/or editing access, and other policies that should be associated with a document. The rules application can apply rules as the document is ingested, and/or apply new rules as contents or requirements of the document changes. Rules application 226 also determines which end users are able to access secured content based on credentialing.

A retention policy may depend on the legal and regulatory requirements. Different types of documents are required to be kept for different periods of time. Further, some documents may be kept indefinitely. The retention policy is applied to the document and ensures the document is not destroyed before an appropriate amount of time has passed.

An encryption policy may also depend on the legal and regulatory requirements for the document. The rules application 226 can communicate with encryption application 232 as needed to encrypt the appropriate documents in an appropriate period.

A viewing and/or editing access policy may also depend on the legal and regulatory requirements associated with the document. The rules application 226 can apply a viewing policy to the document, which restricts viewing access to a document to only authorized users. The rules application 226 can also apply an editing policy to the document, which restricts editing access to the document to only authorized users. The same user may have viewing access, but not editing access. In an example embodiment, only a member of a legal team is able to view and/or edit legal documents maintained by the system 220.

In another example, when a document is processed through ingestion application 222, a class is defined by rules application 226. Each class is defined by a different set of retention rules. Some documents may be included in a class that has a retention policy of 7 years, while other documents may be included in a class that has an indefinite retention policy. Still further, some documents may be included in a class that has no retention policy, and may be deleted by an end user.

A destruction application 228 deletes and purges documents when a retention time period expires. Destruction application 228 communicates with rules application 226 to determine when an appropriate time is to destroy a document. Destruction application 228 also determines how much of the document and associated metadata should be deleted. In a first example, the entire document and all associated metadata are deleted. In another example, only the drafts of the document are deleted and a final copy is retained.

Indexing/storage application 230 indexes and stores documents after they have been fully processed by the other applications. Indexing stores the document as required by the rules application 226 and allows the document to be quickly and easily retrieved as needed. Indexing/storage application 230 includes determining where to store documents.

When a user desires to view a document that has been processed by the system 200, the user must be authorized by the rules application 226. Then the indexing/storage application 230 can retrieve the document and allow the user to view/edit the document.

Encryption application 232 encrypts the data from the documents as needed. The encryption requirement is determined by features of the document, such as the type of document, who uploads the document, the categorization associated with the document, and other classification information. Encryption application 232 communicates with rules application 226 to determine which content needs to be encrypted. Content requiring encryption may be referred to as secured content. Secured content may only be accessed by computing device 150 with appropriate credentials or access rights. Such access rights are defined by rules application 226. While some content needs to be encrypted, not all content is requires encryption.

Activity log 234 logs and retains all information that occurs in relation to a document. For example, the activity log 234 stores when the document was uploaded, the upload source, the individual (or program) that upload the content, the rules applied to the content, and other information related to the document, including metadata. Such background information, metadata, is used to track, access, save, dispose, etc., the document.

In an example, the date and time of the movement of a document is logged by the activity log 234. In a further example, the activity log 234 tracks and records which users access the document. All interaction with documents is maintained through a single internal point, so all activities are logged. Example activities include viewing the document, deleting a document, or filing a declaration.

Image data application 236 maintains and provides an image of each of the documents. The image data application 236 may capture images associated with hard-copy documents that are received by the organization system 220. Image data application 236 may use a variety of methods to capture images and extract data from the document. For example, optical character recognition (OCR), intelligent character recognition (ICR), or other text processing methods may be used, and an image processing method may process images.

In a further example, the image may be a thumbnail, which is displayed when viewing the whole document in not required. In another example, the image is a readable document, which is displayed when the document only needs to be viewed. In yet another example, the image is writeable document, which is only available to users that have access according to a set of rules.

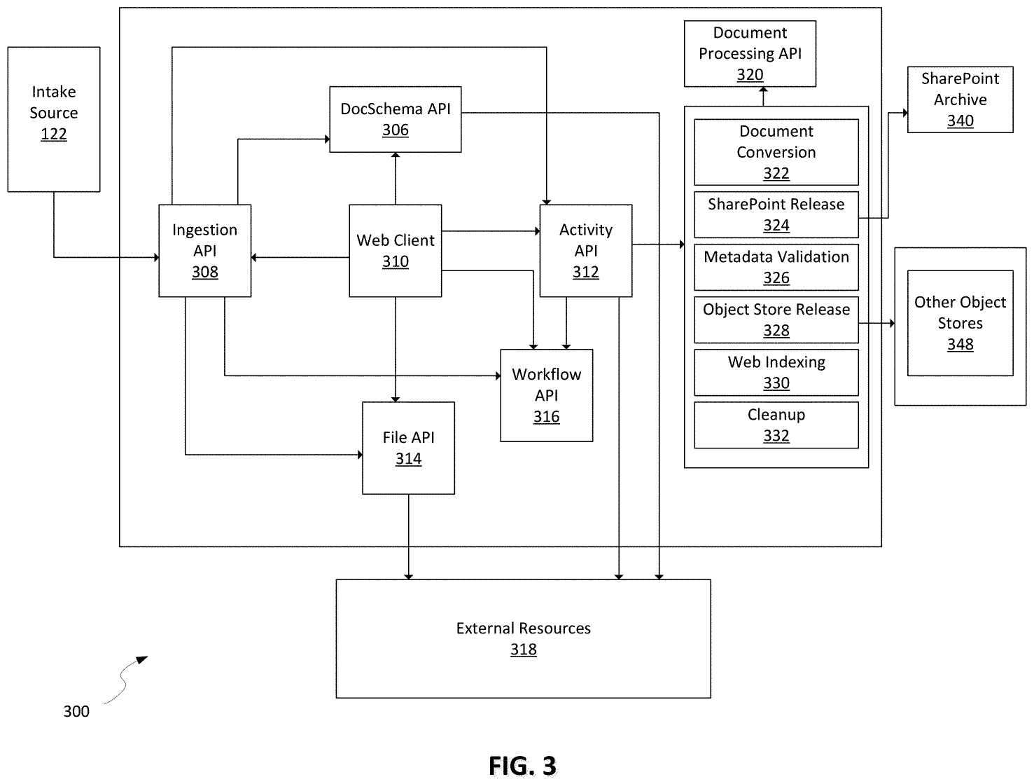

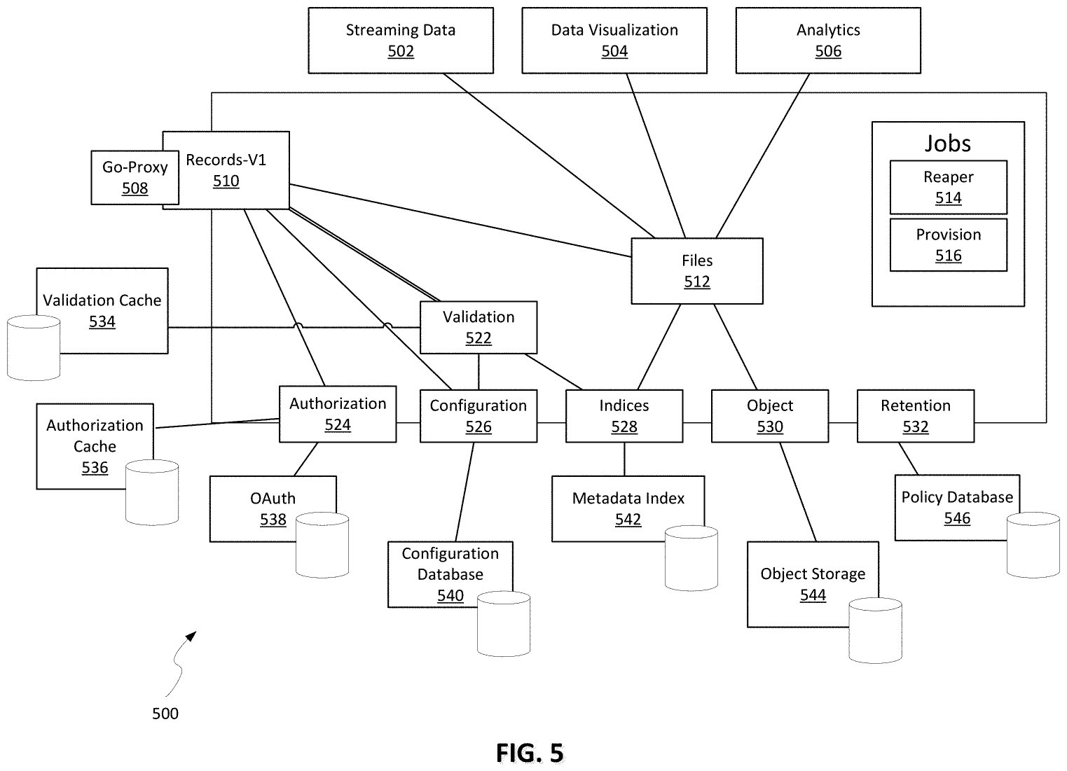

FIG. 3 illustrates an example block diagram of a microservices architecture 300 for ingesting documents and storing documents within an enterprise system. The microservices architecture 300 represents a possible arrangement of the system 200 of FIG. 2 in which each of the applications described therein are assigned to one or more microservices for flexible, scalable processing of received documents. A more specific definition of microservices useable to implement the system is illustrated and discussed below in connection with FIG. 5.

In the embodiment shown, documents are ingested from intake source 122. Intake sources include business applications, email import jobs, scanners, manual electronic upload, and faxes. Ingestion API 308 receives and processes all requests associated with a document, including requests to access, store, or modify a document. In conjunction with document storage requests, the ingestion API 308 can store the document and information associated with the document that may be present at the time the document is received. The ingestion API 308 may also attach to the document specific information associated with a workflow to be performed on the document. For example, the ingestion API 308 can attach specific processing required for a particular document, such that the document is forwarded to different microservices (accessible by the various APIs) for further processing. Accordingly, the ingestion API 308 represents a single access point into the system 200 for purposes of document processing, retention, and audit requests.

Processing APIs include docschema API 306, workflow API 316, file API 314, and activity API 312. Documents do not need to be processed by all the APIs, nor do they need to be processed in a specific order. Documents are processed by the different APIs as necessary.

Activity API 312 functions to process and log activity that has occurred to the document. Activity API 312 may also communicate with other applications that perform activity functions. Examples include document conversion 322, which converts documents into different formats; SharePoint release 324, which manages the transmission of documents to external systems, and applies user access rights to the document; metadata validation 326, which validates the metadata associated with the document; object store release 328, which manages release of documents from the storage medium to one or more external data stores for use within the enterprise, as discussed further below; web indexing 330, which exposes a graphical user interface for the manual classification and indexing of documents, so the documents can be found more quickly at a later date via a web search and proper retention can be executed (e.g., within the enterprise); and cleanup 332, which scrubs document metadata and/or manages deletion of stored documents according to a predetermined policy.

Document conversion 322 can communicate with document processing API 320 to convert documents stored using the system 200 for external viewing. In example embodiments, the document processing API 320 represents a service that converts documents between established standards such as TIFF or PDF. Such a service may be particularly useful in the event stored documents are required to be obtained and converted for viewing/use.

SharePoint release 324 communicates with a SharePoint archive 340 for purposes of retrieval of documents that are stored for audit or discovery (e.g., in the event of litigation or audit processes occurring within the enterprise). Object store release 328 can communicate with other storage solutions, such as object stores 348. These storage mechanisms function to organize documents for quicker retrieval and also allow for quicker access to credentialed users.

DocSchema API 306 analyzes metadata associated with a particular document and can identify a location within a schema for storage of the document, and optionally modify a schema to accommodate documents based on the metadata of documents analyzed. In example embodiments, the docschema API 306 is implemented as a microservice that provides documents according to a particular schema for storage in an external database included within external resources 318, such as a relational database.

Workflow API 316 maintains and stores information about processes that are required to be performed with respect to each document. For example, all the processes to be applied to a document are tracked by the workflow API 316, and as processes are performed on the document, record of such processes applied to the document are recorded. As above, the workflow API 316 can similarly be implemented using a microservices architecture, and be scalable in terms of computing resources consumed or number of instances of such an API in response to a number of documents handled by the system 200.

File API 314 stores the document in an appropriate location within external resources 318. The appropriate location is determined by the DocSchema API 306 and Activity API 312.

As noted above, each of the APIs, implemented as microservices, can also communicate with external resources 318. In particular, some of the APIs are specifically designed for preparation of document data for use with certain external resources. Some example external resources 318 include certificate management, encryption, file store, activities, configuration, and logging. The external resources can perform functions as described below. A certificate management resource can store and manage certificates that may be generated or received with respect to certain secure documents. An encryption resource encrypts documents that have been indicated as documents that are required to be encrypted. It is noted that, in various embodiments, not all documents in an enterprise system need to be encrypted. A document based database can be interfaced with the File API 314 for managing storage and a schema used for document storage while a relational database management system can be interfaced for with the DocSchema API 306 and Activity API 312. A logging application may also be used to store activity logs that occur with respect to the document. Other resources may be used as well, in further embodiments.

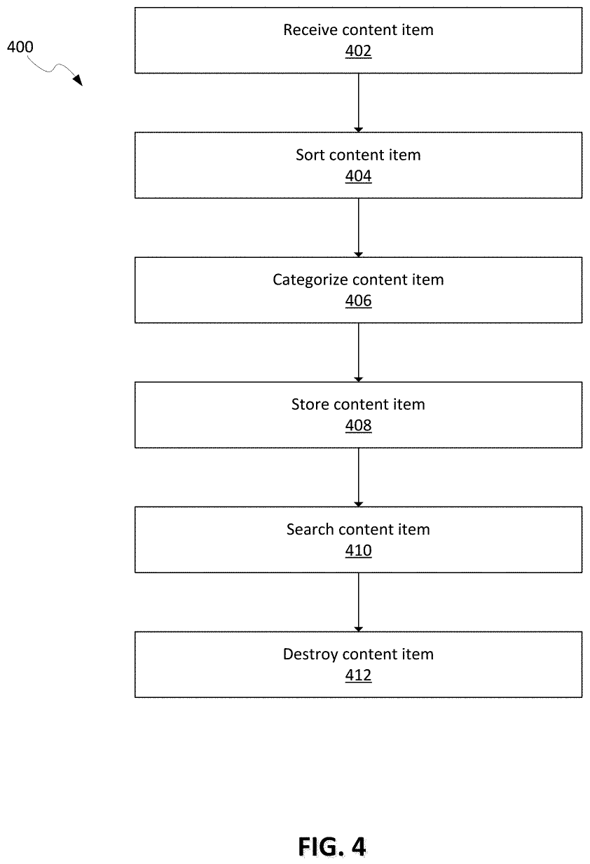

FIG. 4 illustrates an example method 400 of ingesting, processing, and storing content according to an example method of using the document management storage system as described herein. At 402, the document is received. The document may be received from an intake source 122 at a single exposed interface (e.g., ingestion API 308) of microservice architecture 300. The document(s) received may be an electronic document or paper documents converted to digital files. Example types of documents include email, figures, spreadsheets, presentations, text document, emails, other correspondence, and audio files.

At 404, the documents are sorted. Sorting the documents includes determining where the document needs to go for further processing. A rules application may help determine where the document needs to go, and then the document is sorted accordingly. Allowing documents to only be processed by applicable applications reduces processing times and computing power.

At 406, the documents are categorized. Categorization includes processing the documents and associating each document with the corresponding one or more processing microservices included in the microservice architecture 300. Categorization also includes utilizing the rules applied to the document, so it is stored properly.

At 408, documents are stored. The documents are stored in accordance with a retention policy. Where and how long the documents are stored depends on the type of document, the information contained in the document, and other similar properties. For example, e-mail communications may be saved for 7 years, while a signed contract may be stored indefinitely. Various policies may be adopted for documents of different document types, received from different sources, or controlled by different departments within the enterprise.

At 410, the document is searchable. After the document has been processed, the document can be searched for various search parameters. The documents may be searchable based on the name of the document, the type of document, the contents of the document, and the metadata of the document, etc. Further, the document may only be searchable for authorized users. The document may be searched by an application as directed by a user, or the user may search the document itself.

At 412, the documents are destroyed. A destruction policy determines when the documents may be destroyed. After the retention policy indicates that a document is no longer required to be stored, the document is destroyed. Depending on the destruction policy, the entire document and associated metadata, or less than the entire document may be destroyed.

Referring to FIG. 4 generally, it is noted that the various steps described herein may be performed in a variety of orders. Furthermore, the steps may be performed more than once per document, and at different times altogether.

FIG. 5 illustrates a more detailed view of a system architecture 500 for managing and storing documents. As shown, each microservice is capable of communicating with other microservices, with the microservices cooperating to expose the APIs described in FIG. 3.

In the example shown, documents are received at the records service 510 after traveling through go-proxy 508 from different sources, such as line of business applications, scanners, graphical user interfaces, and other connected systems. Once the documents are received at records service 510, they are processed by various other microservices.

The system architecture 500 for managing and storing documents provides, in the embodiment shown, at least five main functionalities, which are described in more detail below. In connection with FIG. 5, the main functionalities include defining records, declaring records, discovering records, downloading records, and destroying records.

Defining document classes includes utilizing at least selected microservices of those shown in FIG. 5. In an example implementation, defining document classes can include receiving a request via go-proxy 508 and records service 510. A configuration for the document class can be generated by accessing configuration service 526 and configuration database 540. A provision service 516 then is used to provision the document class by passing the configuration data to the files service 512, indices service 528 and metadata index 542, and object service 530 and object storage 544.

Declaring records includes, in some embodiments, utilizing the following microservices: go-proxy 508 and records service 510 (for handling requests), authorization service 524, validation service 522 validation cache 534 for validation of the record metadata, and configuration service 526 and configuration database 540 for configuration of the record. Then, the following APIs are utilized if authorization and metadata is validated: files service 512, indices service 528 and metadata index 542, and object service 530 and object storage 544.

Discovering records includes, in the embodiment shown, utilizing the following microservices: go-proxy 508 and records service 510 for managing a discovery request, authorization service 524 for authorizing the access request, and indices service 528 for identifying the relevant record.

Downloading records includes, in the embodiment shown, utilizing the following microservices: go-proxy 508, records service 510, indices service 528 and metadata index 542, authorization service 524, files service 512, and object service 530 and object storage 544

Destroying records includes, in the embodiment shown, utilizing the following microservices: reaper service 514 monitors for files outside of a retention period via indices service 528 and metadata index 548. Once reaper service 514 has determined which records are to be destroyed, the following APIs are utilized to validate and effectuate the destruction: retention service 532, policy database 546, files service 512, indices service 528 and metadata index 542, and object service 530 and object storage 544.

In addition, a streaming data service 502 is provided to which any change occurring within the overall system can be published (with respect to any document). Accordingly, users who wish to subscribe to the streaming data service and receive the streaming data regarding logged changes can view a record of document storage, discovery, access, download, and deletion by any other parties, which forms a complete audit log with respect to that document.

As noted above, the service is illustrated in FIG. 5 expose the APIs described above in connection with FIG. 3. Accordingly, each of the services may be independently scalable to accommodate requirements of an enterprise. Additionally, as described further below, specific document operations may utilize a subset of the services, and as such, certain services may be in greater demand than others at different points in time. Therefore, the microservices architecture allows those services to scale onto a plurality of computing systems as is needed to accomplish the tasks required to implement the APIs that are called in response to document submissions or requests.

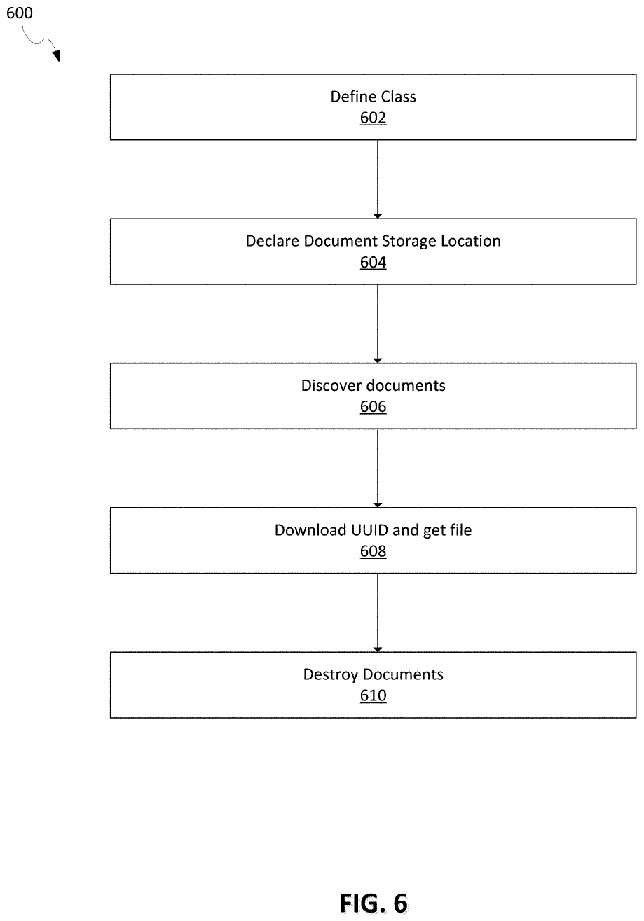

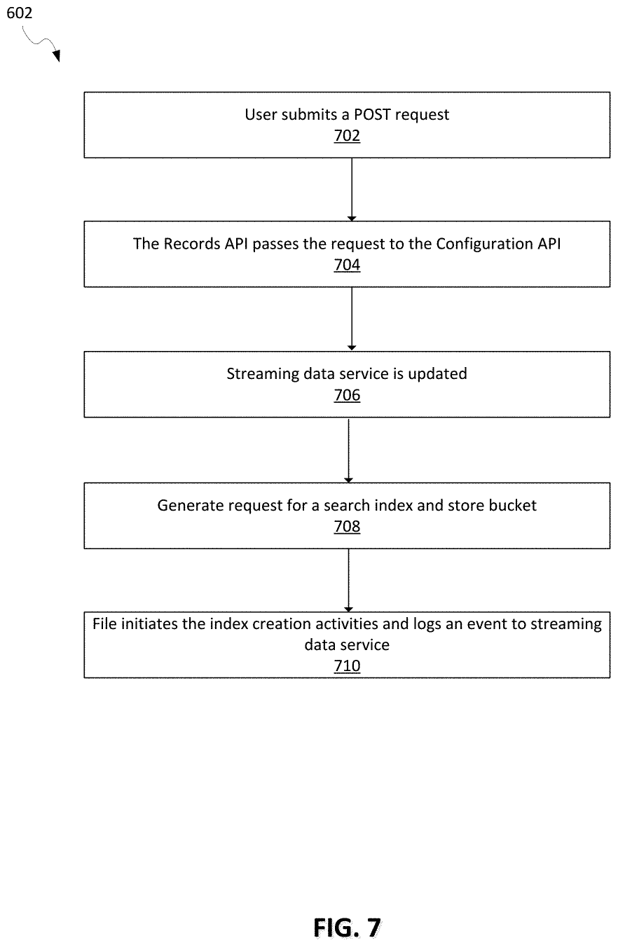

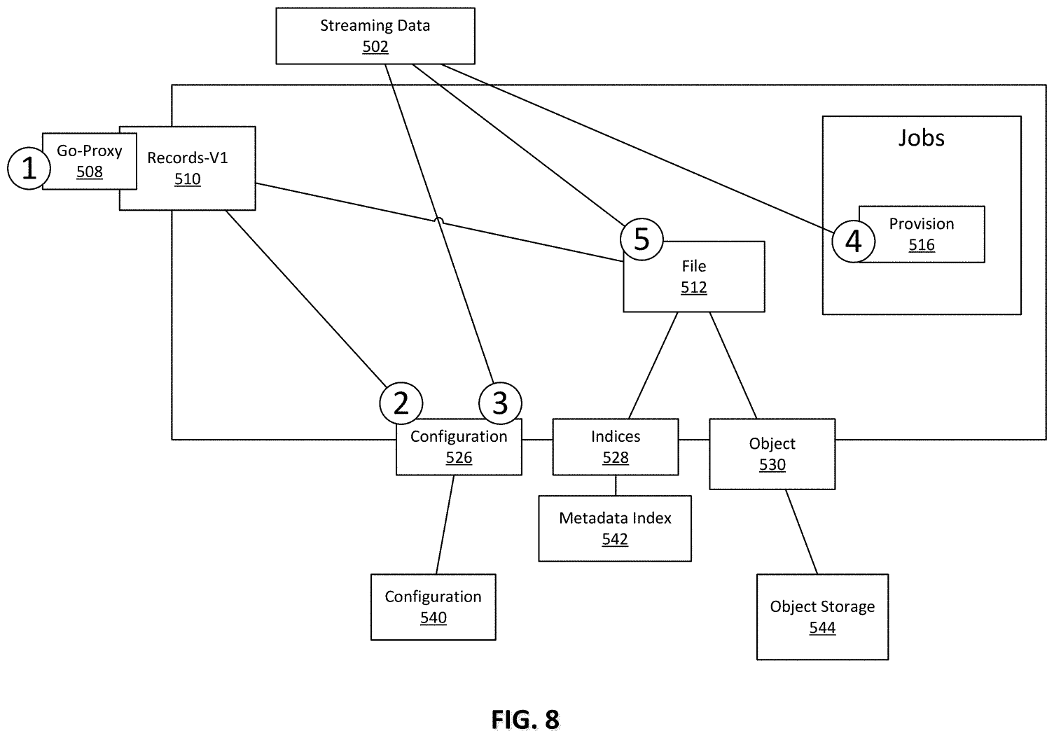

FIG. 6 shows another example method 600 of using a document management system as described herein. The method 600 is a method of ingesting, processing, and storing documents. While documents are referred to below, any type of document may be processed by method 600. At 602, the class is defined. The process of defining a class is described in further detail below with regard to FIGS. 7-8.

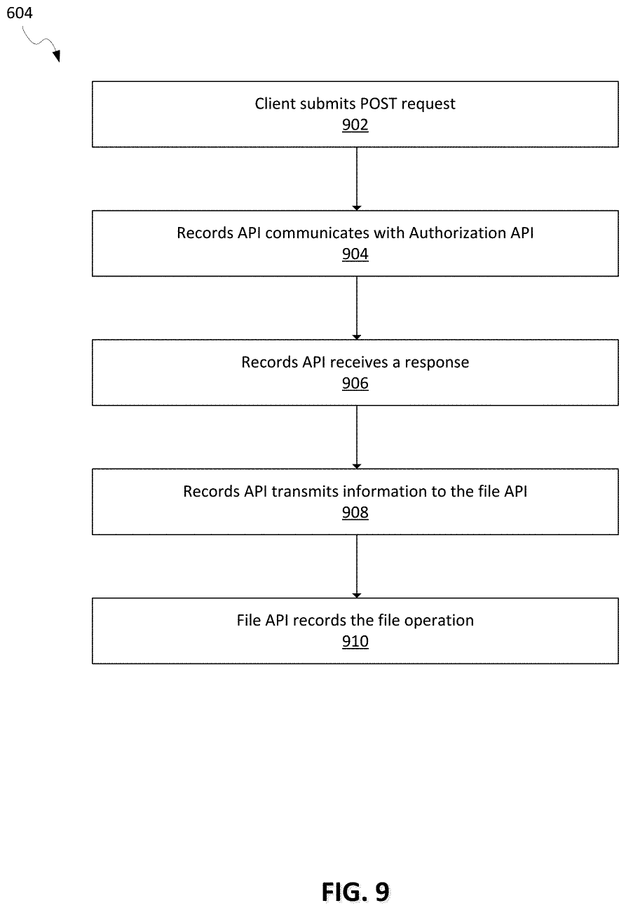

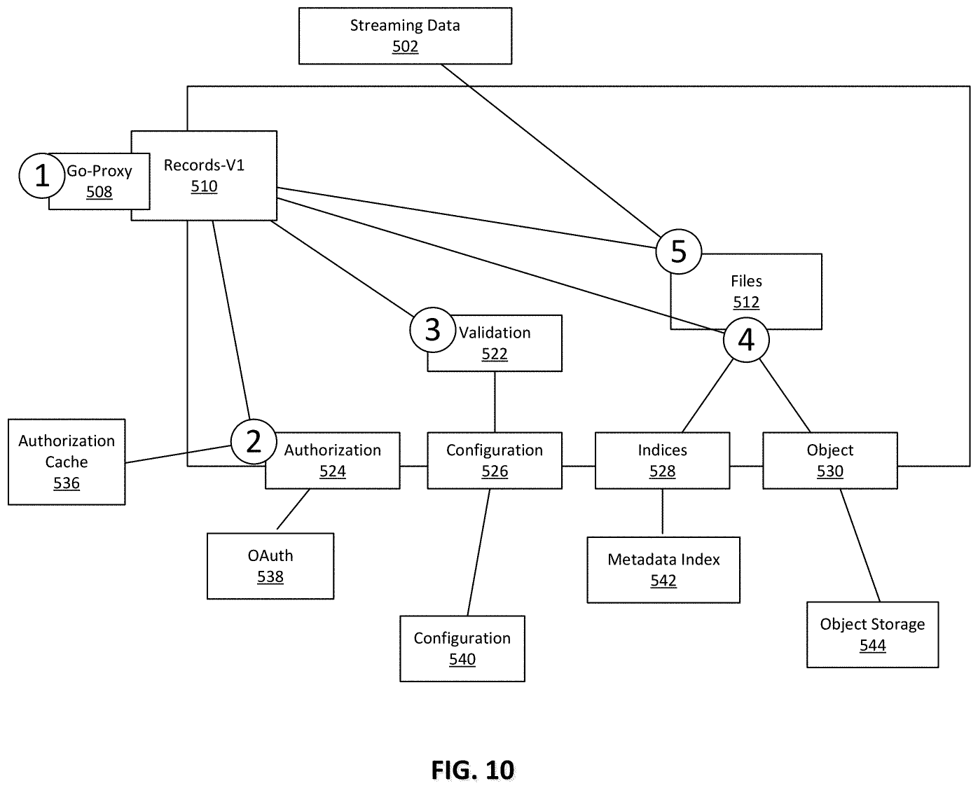

At 604, the document storage location is declared. An example process of declaring document storage location is described in further detail below with regard to FIGS. 9-10.

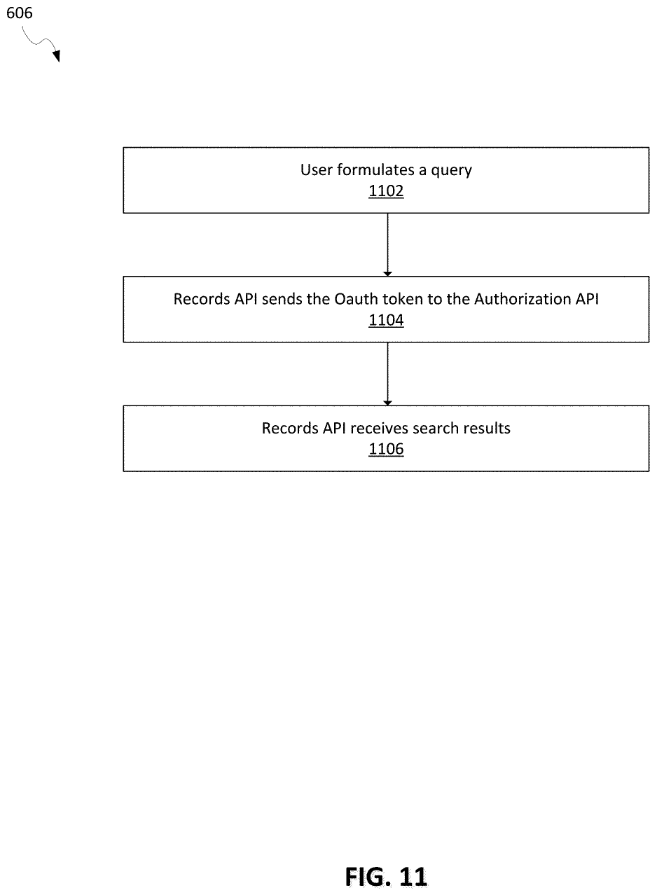

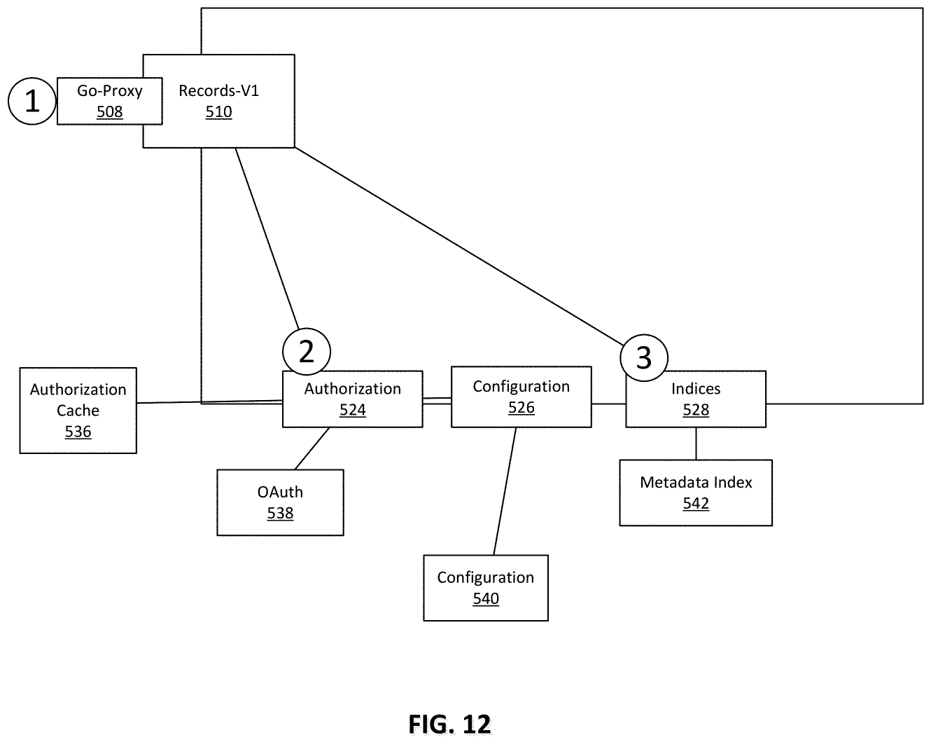

At 606, the documents are discovered. An example process of discovering documents is described in further detail below with regard to FIGS. 11-12.

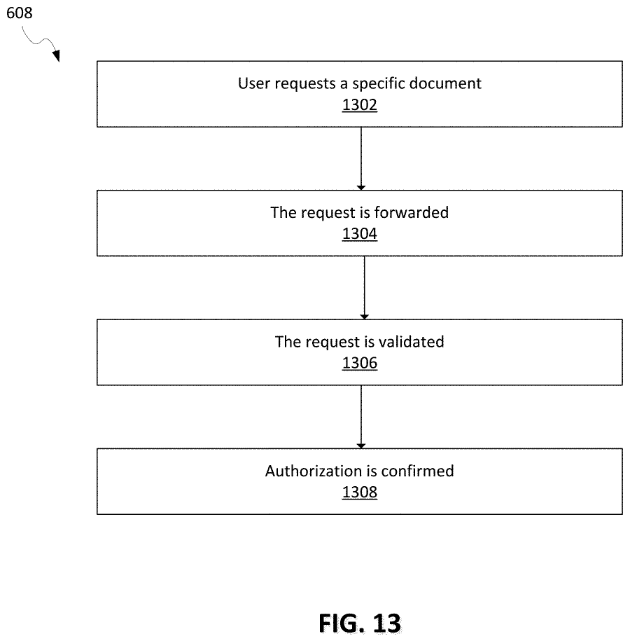

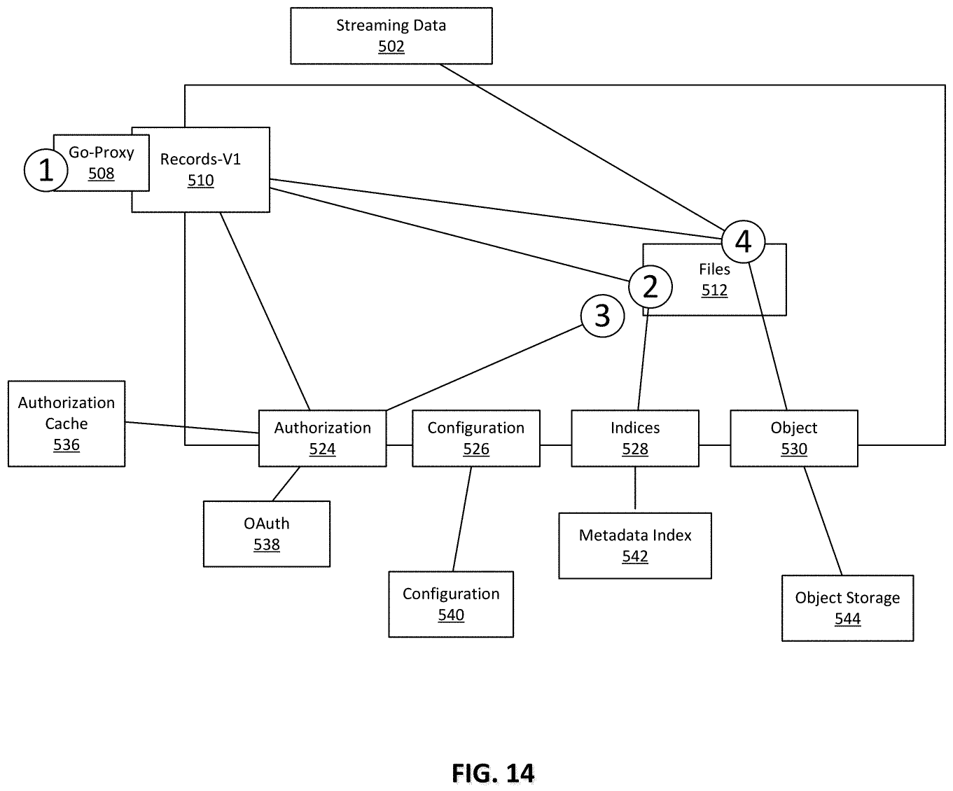

At 608, the universal unique identifier (UUID) is downloaded and the file is retrieved. The process of retrieved documents is described in further detail below with regard to FIGS. 13-14.

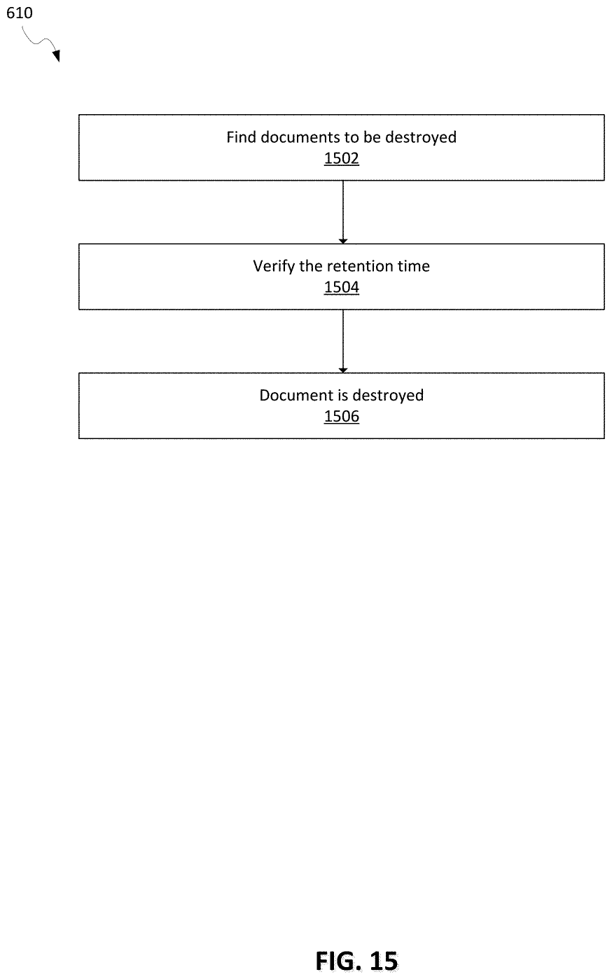

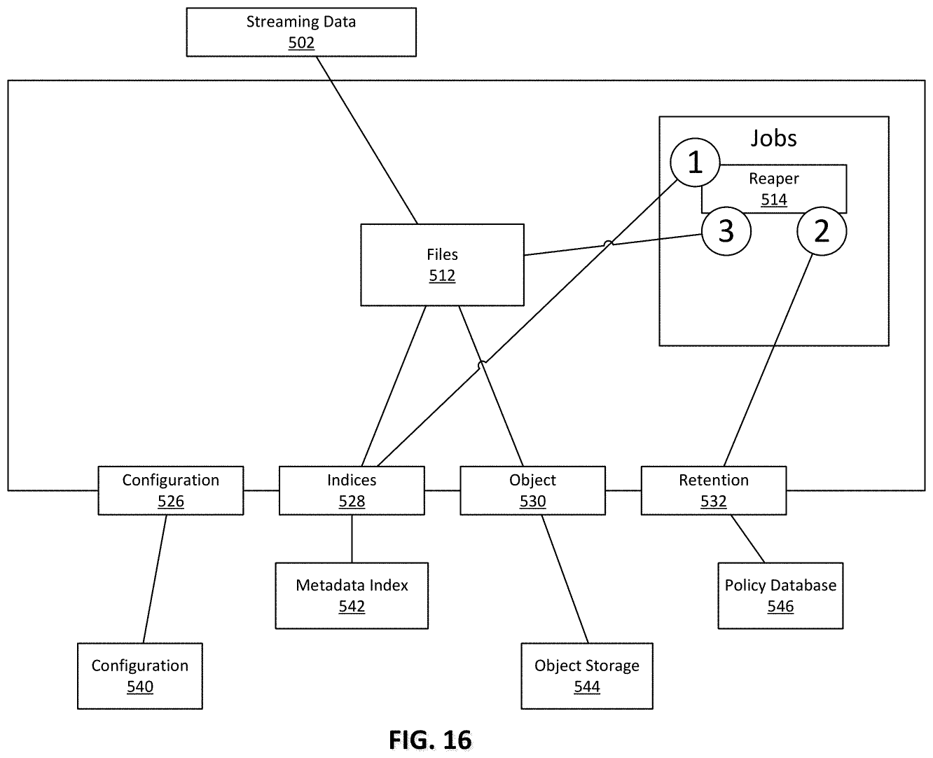

At 610, the documents are destroyed. An example process of destroying documents is described in further detail below with regard to FIGS. 15-16.

FIG. 7 illustrates a more detailed method of defining the document of step 602 of FIG. 6. At 702, a user submits a POST request. A user may be an individual, such as an employee of the enterprise. Alternatively, a user may be represented by an automated process, such as a search engine. The user submits a POST request with a JSON description of the document class, an OAuth token, and an API key.

At 704, the records service passes the request to the configuration service.

At 706, a streaming data service is updated. The configuration service updates the streaming data service with each document class that is requested, approved, and/or rejected.

At 708, a request is generated for a search index and store bucket. The provisioning service subscribes to the streaming data service, and waits for the document class approval events. Then a request is generated for a search index and an object store bucket is created.

At 710, the file initiates the index creation activities and logs an event to the streaming data service.

FIG. 8 illustrates the system architecture useful for implementing the method of FIG. 7. In particular, the system architecture of FIG. 8 represents the portions of architecture 500 used in the process of document ingestion and storage. When a user submits a POST request, it is received at go-proxy 508 of records service 510. The records service 510 sends the request to the configuration service 526. Then the document is processed by the configuration service 526. The configuration service updates a streaming data service 502 with each document class that is requested, approved, or rejected.

Next, the provision service 516 subscribes to streaming data service 502 and waits for the document class approval event. After the document class has been approved, the provision service 516 generates a request for a search index and creates an object store bucket.

Then, the document is processed by the files service 512. The files service 512 initiates the index creation activities and logs an event to streaming data service 502.

FIG. 9 illustrates a more detailed method of declaring the document of step 604 of FIG. 6. At 902, a client submits a POST request. The POST request includes a file, metadata, OAuth token, and an API key.

At 904, the records service communicates with the authorization service to determine if the requested user is an authorized user. The records service sends the OAuth token and doc-class to authorization service to establish if the user has access to declare the document requested.

At 906, the records service receives a response. The records service sends all the metadata to the validation service and receives a fully validated and appended JSON response that includes all required metadata to store the record according to the document class definition defined in FIG. 8.

At 908, the records service transmits information of the files service. The information includes object information and metadata information. The records service transmits both the object and metadata to the files service. The files service sends the metadata to a metadata index and the object and metadata to an object store.

At 910, the files service records the file operation. The files service records the file operation to the streaming data service, and returns a response to the client via a records service that includes the document UUID.

FIG. 10 illustrates the system architecture useful for implementing the method of FIG. 9. When a user submits a POST request, it is received at go-proxy 508 of records service 510. Then the document is processed by the authorization service 524. The authorization service receives the request along with the file, metadata, OAuth token, and API key.

Then the request is sent to the authorization service 524. After the authorization service 524 determines if the user has access to the document, the records service 510 send the document metadata to the validation service 522. The validation service 522 validates the metadata and appends all additionally required metadata to store the record according to the document class definition defined in FIG. 8. Then the records service 510 sends the request to the files service 512. The files service sends the file and metadata to the object store. Then, the files service 512 sends the metadata to the metadata index 542. The files service 512 records the file operation to streaming data service 502.

FIG. 11 illustrates a more detailed method of discovering the document of step 606 of FIG. 6. At 1102, a user formulates a query. The user formulates a search query and submits a request to the records service along with an OAuth token and an API key.

At 1104, the records service sends the OAuth token to the authorization service. After the records service sends the token, the records service receives an array of all document classes valid for that token.

At 1106, the records service receives the search results. The records service appends the approved document classes to the query, sends it to the indices service and receives search results in response.

FIG. 12 illustrates the system architecture useful for implementing the method of FIG. 11. A user formulates a query and sends it to the go-proxy 508 of the records service 510. Then the records service 510 sends the request to the authorization service 524 for approval.

The request is sent back to the records service 510, and then it is sent to the indices service 528. The indices service 528 returns the results.

FIG. 13 illustrates a more detailed method of downloading the document of step 608 of FIG. 6. At 1302, a user requests a specific document. The request uses a UUID that is identified as part of the discovery flow in FIG. 11. The request is sent to the records API and includes the UUID, OAuth token, and an API key.

At 1304, the request is forwarded. The records service forwards with UUID and token to the files service.

At 1306, the request is validated. The files service determines the document class associated with the UUID by querying the indices service, and validates that the OAuth identity has access to it by querying the authorization service.

At 1308, authorization is confirmed. Once authorization is confirmed, the files service returns the binary and metadata to the user and publishes the activity to a streaming data service.

FIG. 14 illustrates the system architecture useful for implementing the method of FIG. 13, according to an example embodiment. In the example shown, a user request is received for a specific document at go-proxy 508 of the records service 510. The records service 510 forwards the request to the files service 512.

The files service 512 receives the location of the document from indices service 528 and then the files service 512 authorizes the request by receiving authorization from the authorization service 524. After authorization is confirmed, the files service 512 publishes the activity to streaming data service 502. Accordingly, even in the instance of a document access, a log of document operations can be published via the streaming data service 502.

FIG. 15 illustrates a more detailed method of destroying the document of step 610 for FIG. 6, in an example embodiment. At 1502, documents to be destroyed are located. A reaper service polls the indices service for documents that have reached their retention date.

At 1504, a retention time is verified. The retention time can be a predetermined time stored in a policy database, such as the policy database 546 as illustrated. The reaper service verifies that the retention calculation defined from the document matches the current definition accessed via the retention service 532.

At 1506, the document is destroyed. The reaper immolates the file and updates the streaming data service 502 with a record of the event.

FIG. 16 illustrates the system architecture useful for implementing the method of FIG. 15, according to an example embodiment. The reaper service 514 receives indication of which documents are to be destroyed. The reaper service 514 confirms the destroy date with the retention service 532.

Once the retention service 532 confirms the destroy date, the reaper service 514 destroys the document and notifies the streaming data service 502.

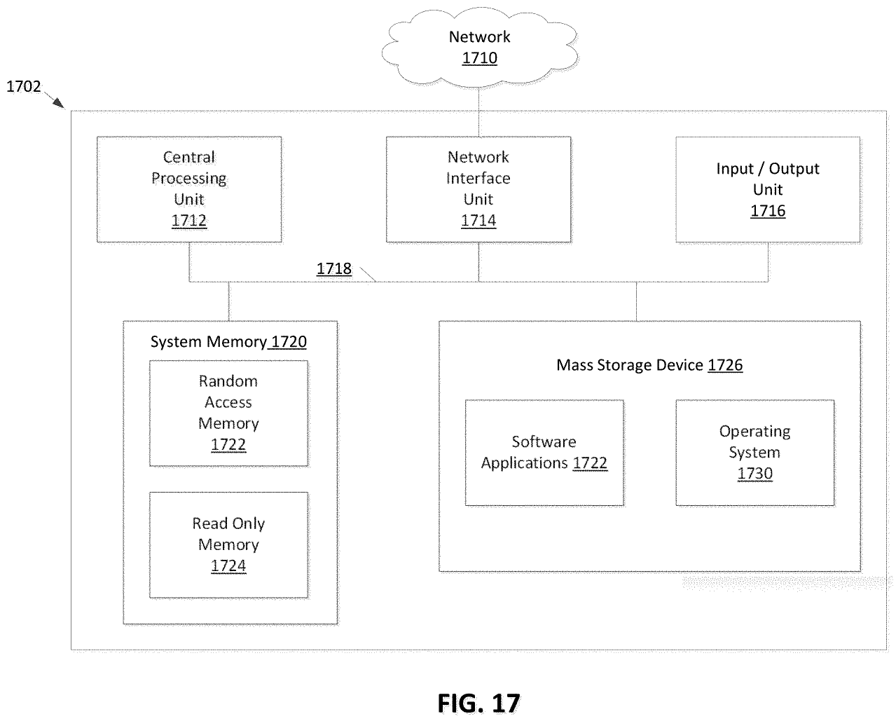

Referring now to FIG. 17, an example block diagram of a computing system 1702 is shown that is useable to implement aspects of the system 200 of FIG. 2. As above, although a single computing system is described and illustrated in the present response, in typical implementations, multiple computing systems may be used, and the number of computing systems may vary over time as the microservices used to implement the system 200 scale up and down to accommodate enterprise requirements.

In the embodiment shown, the computing system 1702 includes at least one central processing unit (“CPU”) 1712, a system memory 1720, and a system bus 1718 that couples the system memory 1720 to the CPU 1712. The system memory 1720 includes a random access memory (“RAM”) 1722 and a read-only memory (“ROM”) 1724. A basic input/output system that contains the basic routines that help to transfer information between elements within the computing system 1702, such as during startup, is stored in the ROM 1724. The computing system 1702 further includes a mass storage device 1726. The mass storage device 1726 is able to store software instructions and data.

The mass storage device 1726 is connected to the CPU 1712 through a mass storage controller (not shown) connected to the system bus 1718. The mass storage device 1726 and its associated computer-readable storage media provide non-volatile, non-transitory data storage for the computing system 1702. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 1712 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 1702.

According to various embodiments of the invention, the computing system 1702 may operate in a networked environment using logical connections to remote network devices through a network 1710, such as a wireless network, the Internet, or another type of network. The computing system 1702 may connect to the network 1710 through a network interface unit 1714 connected to the system bus 1718. It should be appreciated that the network interface unit 1714 may also be utilized to connect to other types of networks and remote computing systems. The computing system 1702 also includes an input/output unit 1716 for receiving and processing input from a number of other devices, including a touch user interface display screen, or another type of input device. Similarly, the input/output unit 1716 may provide output to a touch user interface display screen or other type of output device.

As mentioned briefly above, the mass storage device 1726 and the RAM 1722 of the computing system 1702 can store software instructions and data. The software instructions include an operating system 1730 suitable for controlling the operation of the computing system 1702. The mass storage device 1726 and/or the RAM 1722 also store software instructions, that when executed by the CPU 1712, cause the computing system 1702 to provide the functionality discussed in this document. For example, the mass storage device 1726 and/or the RAM 1722 can store software instructions that, when executed by the CPU 1712, cause the computing system 1702 to receive and analyze inventory and demand data.

Referring to FIGS. 1-17 generally, it is noted that the systems and methods of the present disclosure provide a number of advantages for use within an enterprise as compared to existing systems. For example, as compared to existing monolithic software systems used for document retention, the microservices architecture of the present disclosure allows for custom scalability of each of the services such that when document requests are issued to a particular API, the services supporting that API can scale up or down as needed to meet the needs of different types of requests received. This reduces overall computing requirements relative to existing systems, which require purchase of scaling capabilities with respect to the software monolith as a whole.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A system for managing unstructured documents within an enterprise system, the system comprising,
a computing system including one or more computing devices and comprising at least one processor communicatively connected to a memory, the memory configured to store instructions which, when executed, cause the computing system to:
expose an application programming interface (API) representing a single access point to a document management repository including a plurality of microservices comprising:
an ingestion microservice configured to receive at least one document, wherein the document is an unstructured document, and process the at least one document for storage;
a metadata microservice configured to apply metadata to the at least one document, the metadata selected from tagging the at least one document with a time, date, creator, security policy, and destruction policy;
a retention policy microservice configured to apply a minimum retention period and a destruction policy; and
a storing microservice configured to store the at least one document and associated metadata for at least the minimum retention period,
wherein each microservice is capable of functioning independently of each other microservice.

2. The system of claim 1, wherein the ingestion microservice, metadata microservice, retention policy microservice, and storing microservice are configured to work independently of each other.

3. The system of claim 1, wherein each microservice is independently scalable.

4. The system of claim 1, wherein the computing system is distributed across a plurality of computing devices.

5. The system of claim 1, wherein the metadata microservice is configured to communicate with the ingestion microservice, the retention policy microservice, and the storing microservice, to log activity associated with the at least one unstructured document.

6. The system of claim 1, further comprising a destruction microservice configured to destroy the at least one unstructured document upon expiration of the minimum retention period.

7. The system of claim 1, further comprising a security policy microservice configured to control access to the at least one unstructured document according to a security policy.

8. The system of claim 1, wherein the storing microservice is further configured to index the at least one unstructured document.

9. The system of claim 1, wherein the unstructured document has a document type selected from among a plurality of document types consisting of: TIFF, PDF, text-based document, email, and picture document types.

10. A method of processing at least one unstructured document from an enterprise system, the method comprising:
ingesting at least one unstructured document at an ingestion service, and processing the at least one unstructured document for storage;
applying metadata to the at least one unstructured document by a metadata service, the applying metadata including tagging the at least one unstructured document with at least one of a time, date, creator, security policy, and destruction policy applying a minimum retention period to the at least one unstructured document by a retention policy service,
applying a destruction policy to the at least one unstructured document by the retention policy service; and
storing the at least one unstructured document and associated metadata for at least the minimum retention period by a storing service.

11. The method of claim 10, further comprising destroying the at least one unstructured document upon expiration of the minimum retention period.

12. The method of claim 10, further comprising applying an access policy configured to allow access to the at least unstructured document to authorized users.

13. The method of claim 12, wherein the authorized user has read only permissions.

14. The method of claim 13, wherein the authorized user has write permissions.

15. The method of claim 10, wherein ingesting the at least one unstructured document comprises scanning a hard-copy document, email, text document, picture, fixed format document.

16. The method of claim 10, wherein ingesting the at least one unstructured document further comprises preforming an optical character recognition.

17. A system architecture for managing unstructured documents within an enterprise system, the system comprising,
a computing system comprising at least one processor communicatively connected to a memory, the memory storing computer-executable instructions comprising an application programming interface (API),
means for receiving at least one unstructured document and processing the at least one unstructured document for storage;
means for applying metadata to the at least one unstructured document;
means for applying a retention policy comprising a minimum retention period and a destruction policy to the at least one unstructured document; and
means for storing the at least one unstructured document and associated metadata for the minimum retention period;
wherein the means for receiving, the means for applying metadata, the means for applying a retention policy, and the means for storing are capable of communicating with other and capable of functioning independently of each other.

18. The system of claim 17, wherein the means for receiving, the means for applying metadata, the means for applying a retention policy, and the means for storing are independently scalable.

19. The system of claim 17, further comprising a means for destroying configured to destroy the at least one unstructured document upon expiration of the minimum retention period.

20. The system of claim 17, further comprising a means for applying security configured to control access to the at least one unstructured document according to a security policy.
